(19) United States
(12) Patent Application Publication
(10) Pub. No.: US 2015/0047458 A1
(43) Pub. Date: Feb. 19, 2015

(54) INERTIA WHEEL ARCHITECTURE FOR STORING ENERGY

(71) Applicants: EUROPEAN AERONAUTIC DEFENCE AND SPACE COMPANY EADS FRANCE, Paris (FR); LEVISYS, Issy Les Moulineaux (FR)

(72) Inventors: Frédéric Cavaliere, Montigny Le Bretonneux (FR); Daniel Aliaga, Aubervilliers (FR); Michel Saint Mleux, Bormes Les Mimosas (FR)

(21) Appl. No.: 14/354,063

(22) PCT Filed: Oct. 24, 2012
(86) PCT No.: PCT/EP2012/071016

§ 371 Date: Apr. 24, 2014

(30) Foreign Application Priority Data
Oct. 25, 2011 (FR) 1159653

(51) Int. Cl. F16F 15/305; B29C 70/06; B29C 70/34

(52) U.S. Cl. CPC F16F 15/305; B29C 70/345; B29C 70/06; F16F 2224/0241; F16F 2226/04; F16F 2234/00; F16F 2230/00; B29L 2009/00
USPC 74/572.21; 156/211

(57) ABSTRACT

An inertia wheel including a storage ring and a hub connecting the storage ring to a rotation shaft of the wheel, the hub including a central part forming a hub body for connecting to the shaft, a peripheral part forming a rim for connecting to the storage ring and an intermediate part formed by a disk between the hub body and the rim. The hub is made from a composite material and includes a module having a stiffness that decreases from the hub body to the rim. A method for producing such an inertia wheel is also provided.

### CROSS-REFERENCE TO RELATED APPLICATIONS

This application is the National Stage of International Application No. PCT/EP2012/071016 having International filing date 24 Oct. 2012, which designated the United States of America, and which International Application was published under PCT Article 21 (s) as WO Publication 2013/060704 A1 and which claims priority from, and benefit of, French Application No. 1159653 filed on 25 Oct. 2011, the disclosures of which are incorporated herein by reference in their entireties.

### BACKGROUND

The presently disclosed embodiment concerns an inertia wheel architecture for storing energy.

Devices using an inertia wheel to store and return energy are known and the document WO2005021379 A1, for example, concerns an inertia wheel, notably for spacecraft, comprising an inertia mass rotatably mounted on a rolling bearing the fixed part of which is intended to be fixed to the spacecraft, the inertia mass of the wheel incorporating at least one turning race of the bearing, the turning race being fastened without play to the inertia mass.

An application of an inertia wheel is moreover described in the document WO2009047218 A1 which concerns a spacecraft rocket engine feed pump motorization device comprising an inertia wheel and means for transmission of the rotation of the inertia wheel to the pump.

### SUMMARY

The presently disclosed embodiment concerns a composite material inertia wheel architecture enabling optimization of the energy density, i.e. the stored energy/wheel mass ratio.

In addition to the particular space applications cited above, the requirement to store energy to regulate the frequency of an electrical power supply network, to stabilize micro-networks or intelligent networks or to prevent interruptions (uninterruptible power supplies) will increase in future years. For such storage, compared to storage by means of batteries, inertia wheels notably have the benefit of a fast response with a very long service life (number of cycles with a great charge-discharge depth).

However, these wheels often have the disadvantages of having, on the one hand, a high level of self-discharge and, on the other hand, a high cost resulting in particular from the cost of the carbon fibers used in the composite material that stores the energy.

In order to limit these drawbacks, it is necessary to limit the mass of the wheels as much as possible, in other words to increase the stored energy density, i.e. to optimize the stored energy/wheel mass ratio.

Inertia wheels exist already for the same type of applications. The American company BEACON offers inertia wheels with a composite material storage ring as described in the document WO03/026882 A1 and including a metal hub as described for example in the document WO02/37201 A1.

The wheels utilize wound composite cylinders forming energy storage rings that have a small inside radius and are mounted directly on metal hubs.

This configuration has a stored energy/wheel mass ratio that is limited by the fact that the metal hubs rapidly reach their technological limits when the inside diameter of the storage ring of the wheel is increased.

Moreover, the design of these wheels in which the ratio R_{inside}/R_{outside}<0.5 leads to high radial stresses (σᵣᵣ) that limit the rotation speed. This latter drawback is alleviated by using different fibers that have varying stiffnesses, the least stiff fibers being located nearer the rotation axis (at the small radii).

The solution on which the presently disclosed embodiment is based has the object of increasing the R_{inside}/R_{outside} ratio.

In order to optimize this ratio, the presently disclosed embodiment proposes a particular design of the wheel that consists in placing the storage material, for example a carbon fiber composite ring, as far as possible from the rotation axis of the wheel.

To alleviate the problems of the mechanical strength of the hub connecting the ring, the presently disclosed embodiment proposes to produce a hub from composite materials and, to be more precise, proposes an inertia wheel including a storage ring and a hub connecting the storage ring to a rotation shaft of the wheel in which the hub includes a central portion forming a hub body connected to the shaft, a peripheral portion forming a rim connected to the storage ring and an intermediate part consisting of a disk between the hub body and the rim, the hub being made from composite material and having a stiffness modulus decreasing from the hub body to the rim.

The hub is advantageously produced by drape forming and shaping composite plies.

The drape forming preferably produces a pattern including an average number of superposed plies decreasing from the hub body to the peripheral portion of the rim.

In accordance with one particular aspect of the disclosed embodiment the drape forming includes a succession of plies angularly offset and overlapping at least in the central portion of the hub.

The hub body advantageously includes a cut-out to receive the shaft.

In accordance with one particular aspect of the disclosed embodiment the hub body is produced by stamping the central portion of the hub.

The rim is advantageously produced by curving the periphery of the disk.

The hub body more particularly forms a tube, receiving the shaft and fastened to the shaft and is connected to the disk at one of its ends by a first curve, the rim being connected to the disk by a second curve in the same direction as the first curve.

The second curve advantageously forms a flexible connection between the disk and the rim conferring on the rim a radial modulus of elasticity adapted to allow deformation thereof to follow the deformations of the rotating storage ring.

The hub is preferably produced by drape forming with plies, the fibers of said plies being for the most part oriented radially relative to the center of the hub.

In accordance with one particularly advantageous aspect of the disclosed embodiment the drape forming is carried out with plies formed by longitudinal strips disposed with an angular offset relative to one another and centered on the center of the hub.

The longitudinal strips are advantageously of rectangular or even trapezoidal general shape.

In an advantageous embodiment, the hub body advantageously consists of an area of overlapping of all the plies, the disk consists of an area of reduced overlapping of the plies, and the rim advantageously consists of an area of minimum overlapping of the plies.

In accordance with one particularly advantageous aspect of the disclosed embodiment the orientation of the fibers of the plies confers on the rim a circumferential modulus of elasticity adapted to allow deformation thereof to follow the deformations of the rotating storage ring. This is notably important if the plies overlap in the area of the rim.

The hub preferably includes a flexible peripheral portion the circumferential stiffness of which is reduced relative to the center of the hub so that the rim follows the deformations of the storage ring.

The disclosed embodiment further concerns, in a first aspect, a method of producing an inertial wheel including a composite material hub that includes:
a step of producing a plane blank of the hub by depositing composite plies in accordance with a pattern producing a mean thickness of the blank decreasing from the center to the periphery of the blank,
a step of cutting a central opening in the blank,
a step of pressing the blank in a tool conforming the blank into a cup having at its center an annular hub body and at its periphery a rim, and
a step of polymerizing the hub.

If the composite plies are longitudinal strips, the composite plies are deposited by placing strips centered on the center of the hub with an angular offset of the strips relative to one another.

A step of trimming the blank is preferably carried out after the stamping step.

According to a second aspect, the disclosed embodiment concerns a method of producing an inertia wheel including a composite material hub, characterized in that it includes:
a step of producing a blank of the hub by depositing composite plies in accordance with a pattern producing a mean thickness of the blank decreasing from the center to the periphery of the blank on a mold in the shape of a torus conforming the blank into a cup having at its center an annular hub body and at its periphery a rim,
a step of cutting a central opening in the blank, and
a step of polymerizing the hub.

The method advantageously includes a step of mating the hub body to a rotation shaft of the wheel.

The method advantageously includes a step of binding the hub body onto the shaft.

The method advantageously includes a step of mating the ring of the wheel to the rim of the hub.

For wheels of great height the method includes a step of mating at least one second hub with the same orientation to the shaft and to the ring.

### BRIEF DESCRIPTION OF THE DRAWINGS

Other features and advantages of the disclosed embodiment will become apparent on reading the following description of one non-limiting aspect of the disclosed embodiment given with reference to the drawings, which show:

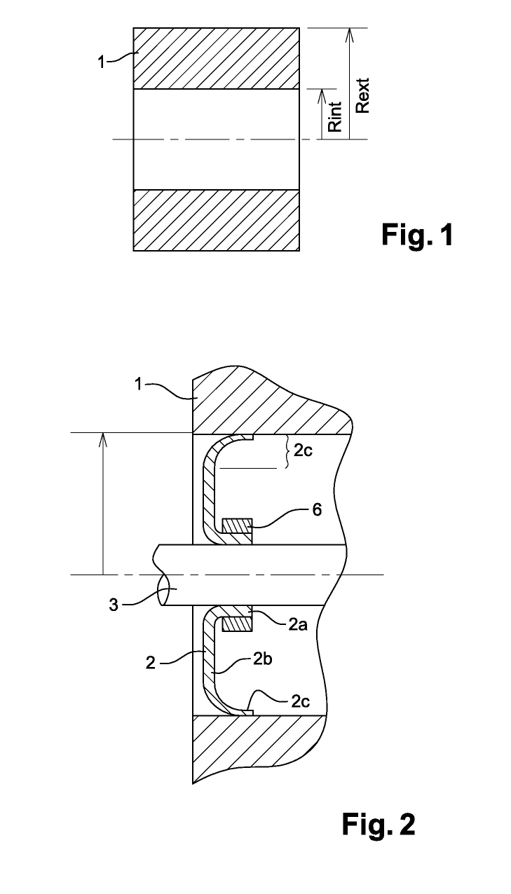

in FIG. 1: a diagrammatic sectional view of an energy storage ring of the disclosed embodiment;

in FIG. 2: a diagrammatic view of a hub blank in accordance with one particular aspect of the disclosed embodiment;

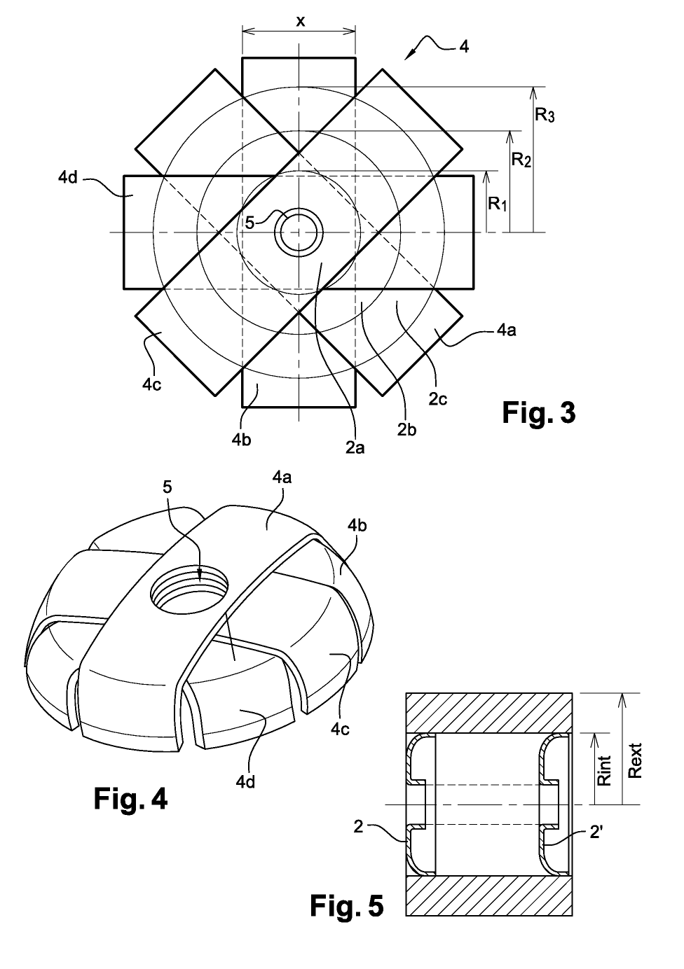

in FIG. 3: a sectional view of a wheel including a hub in accordance with the disclosed embodiment;

in FIG. 4: a diagrammatic perspective view of a hub of the disclosed embodiment; and

in FIG. 5: a sectional view of a wheel including two hubs of the disclosed embodiment.

### DETAILED DESCRIPTION

The disclosed embodiment applies to an inertia wheel including a storage ring 1 as represented in FIG. 1.

The design of the inertia wheel of the disclosed embodiment consists in placing the storage material, notably a carbon fiber composite, as far as possible from the rotation axis of the wheel.

With this design, considering only the composite material cylinder, the energy stored per kg of wheel may be approximate by the equation:

E/mass=(σₘₐₓ/2ρ)×((R²ᵢₙₜ+R²ₑₓₜ)/2R²ₑₓₜ)

in which σₘₐₓ is the maximum stress that the composite material can withstand in the circumferential direction and ρ is the density of this material.

In the proposed solution, as in the usual solutions, the composite material cylinder forming the storage ring is produced by winding pre-impregnated fibers.

Carbon fibers are preferably chosen.

The winding angle is constant or decreases toward the external layers of the cylinder.

This variation of the winding angle advantageously makes it possible to have a less rigid composite material in the internal layers of the cylinder.

In accordance with the aspects of the disclosed embodiment, the hub is composed of fibers oriented in the plane perpendicular to the rotation axis of the wheel and includes a flexible portion the radial stiffness of which is reduced so as to follow the deformations of the cylinder without excessively high stresses.

Accordingly, the proposed design makes it possible to store energy in cylinders having ratios (R²ᵢₙₜ+R²ₑₓₜ)/2R²ₑₓₜ>0.8 whereas the usual wheels have ratios less than 0.7.

The ratios of the presently disclosed embodiment with a carbon fiber composite make it possible to achieve or even to exceed 55 W.h per kg whereas current wheels are limited to approximately 40 W.h per kg.

The hub 2 represented in section in FIG. 2 includes a central portion forming a hub body 2a connected to a rotation shaft 3 of the wheel, a peripheral portion forming a rim 2c connected to the storage ring, and an intermediate portion consisting of a disk 2b between the hub body and the rim is produced in composite material and has a modulus of stiffness decreasing from the hub body to the rim.

The hub is designed to be very rigid at the level of the inside radius near the shaft in order not to separate from the shaft when rotating and more flexible at the level of its outside radius so as to follow the deformations of the energy storage ring or cylinder.

In this example the hub is produced by drape forming and shaping composite plies 4 and the drape forming produces a pattern including an average number of superposed plies decreasing from the hub body to the peripheral part of the rim.

The drape forming may be effected using plies in the form of disks of increasing diameter stacked concentrically but for the example represented in FIG. 3 drape forming employs a succession of plies offset angularly and overlapping in the central portion of the hub.

According to this example, four plies 4a, 4b, 4c, 4d in the form of rectangular longitudinal strips offset by 45° are disposed on one another.

In the hub body portion the four plies are superposed; in the disk portion the superposition is on average of the order of two plies with areas near the center where the superposition is between two and three plies and a peripheral area in which the superposition is for the most part of two plies and in the part forming the rim the plies are juxtaposed over the major portion of the sectors with only a few areas of superposition.

It is possible in accordance with the aspects of the disclosed embodiment to utilize more than four plies by reducing the angle of offset between the plies, for example six plies offset by 30° or eight plies offset by 22.5° are possibilities. It is possible to place a greater number of plies by repeating one of the patterns described above which notably makes it possible to increase the stiffness of the central portion of the hub and by acting on the width of the strips to adapt the degree of superposition at the level of the rim as a function of the required flexibility.

For fixing the hub to the shaft, the hub body 2a includes a cut-out 5 to receive the shaft and the hub body 2a is produced by pressing the central portion of the hub so as to produce a tube for receiving the shaft, the hub body being connected to the disk 2b at one of its ends by a first curve.

The rim 2c is produced by curving the periphery of the disk 2b.

The second curve forms a flexible connection between the disk 2b and the rim 2c conferring on the rim a radial modulus of elasticity adapted to allow deformation of the latter to follow the deformations of the rotating storage ring 1.

In FIG. 3, in the flexible portion of the hub corresponding to the area 2c, the thickness is reduced and the drape forming is such that the circumferential modulus is not too high.

Thus it is possible to drape over a width x that does not cover all the periphery of the rim. In this way there are no or few fibers tangential to the circumference in the flexible part.

The rim may be produced by retaining the portion of the plies with no overlap or, by trimming the hub blank, it is possible to eliminate the external portions with non-contiguous plies to obtain a continuous rim. Moreover, the circumferential stiffness of the continuous rim may be adjusted by adding circumferentially in the rim part continuous fibers with a low modulus, for example glass fibers, or low-modulus or even very-low-modulus carbon fibers. Adding these low-modulus fibers further makes it possible to prevent the occurrence of cracks in the resin of the continuous rim portion on deformation of this rim portion during rotation of the wheel.

The hub is produced by drape forming with four plies 4 the fibers of which are for the most part oriented radially relative to the center of the hub.

In FIG. 3 the fibers are oriented according to the length of the plies produced by longitudinal strips of rectangular general shape.

It is possible to produce the plies with strips having inwardly or outwardly curved longitudinal edges to adapt the flexibility of the rim.

Accordingly, in this example the hub body 2a consists of an area of overlapping of all the plies, the disk 2b consists of an area of reduced overlapping of the plies, and the rim 2c consists of an area of minimum overlapping of the plies.

This makes it possible to reduce the stiffness progressively and step by step from the center to the exterior of the hub.

Similarly, the orientation of the fibers of the plies confers on the rim 2c a circumferential modulus of elasticity adapted to allow deformation thereof to follow the deformations of the rotating storage ring.

Near the axis, the stiffness is increased by a greater thickness and advantageously by the addition of plies or mats consisting of fibers with a higher modulus.

In particular, the hub body 2a extends to the radius R1, the disk 2b extends from the radius R1 to the radius R2 and the rim extends from the radius R2 to the radius R3 and possibly beyond the radius R3 if the portions with non-contiguous plies are retained.

The hub has a flexible peripheral portion the circumferential stiffness of which is reduced relative to the center of the hub so that the rim follows the deformations of the storage ring.

In FIG. 5 a plurality of hubs comprising at least two hubs 2, 2′ is used to provide a perfect connection between the shaft and the composite wheel. The number of these hubs is determined as a function of the modes of resonance of the wheel in the operating speed range.

The hubs are disposed the same way around to prevent phenomena of stresses in opposition at the level of the rims. Hubs disposed the same way around enable deformation of these hubs in the same direction. Deformation in opposite directions would generate shear at the rim/wheel interface of each hub.

In the example represented in FIG. 3, the hub is produced by flat drape forming and shaping before complete polymerization and to produce the hub:
a plane blank of the hub is produced by depositing composite plies 4a, 4b, 4c, 4d in accordance with a pattern producing a mean thickness of the blank decreasing from the center to the periphery of the blank,
a central opening 5 is cut in the blank,
the blank is pressed in a tool conforming the blank into a cup with at its center an annular hub body 2a and at its periphery a rim 2c, and
the conformed hub is polymerized.

The hub after pressing and polymerization is represented diagrammatically in FIG. 4.

When the composite plies 4a, 4b, 4c, 4d are longitudinal strips the composite plies are deposited by placing strips centered on the center of the hub with an angular offset of the strips relative to one another.

It is possible in this case to carry out a step of trimming the blank to the radius R3 after pressing to eliminate the ends of non-contiguous plies.

Pressing may be carried out at raised temperature to facilitate deformation of the blank into a shape not susceptible to development.

The polymerization of the conformed hub is carried out using a heated mold having matrix punch shapes complementary to the finished hub.

Another preferred aspect consists in drape forming the part directly to shape by drape forming plies of rectangular or trapezoidal shape in a mold in the shape of a torus. This makes it possible to avoid the pressing step and to simplify the tooling.

The step of trimming the blank to eliminate the ends of non-contiguous plies is effected after deposition on the mold. The polymerization is then effected on the mold in the shape of a torus.

Then, in both embodiments, to produce the wheel, the hub body 2a is mated to a rotation shaft 3 of the wheel.

The shaft 3 may notably have a conical mating surface to facilitate positioning the hub on the shaft.

Moreover, as shown in FIG. 2, the hub body may be bound onto the shaft at 6 using a wound binding strip to maintain tight contact with the shaft.

The ring 1 of the wheel is then mated to the rim 2c of the hub.

The assembly methods for the hub body/shaft connection and for the rim/ring connection include force-fitting, gluing and the use of assembly techniques relying on differential expansion by cooling one part and heating the other.

In the case of a wheel with a plurality of hubs the ring is fitted onto all the hubs disposed with the same orientation as shown in FIG. 5 in which the wheel includes two hubs.

The inertia wheel of the presently disclosed embodiment is of primary concern to generators and distributor of electricity and electrical network regulators. However, because of its good energy/mass ratio it also applies to aerospace applications and to terrestrial transport.

The target diameters are from 500 mm to 1000 mm and storage of 5 to 15 kWh is envisaged.

The scope of the aspects of the disclosed embodiment is not limited by the example shown, it being notably possible within the scope of the aspects of the disclosed embodiment to envisage a configuration based on a blank using plies of disk shape of increasing diameter.

What is claimed is:

1. An inertia wheel comprising: a storage ring and a hub connecting the storage ring to a rotation shaft of the wheel, wherein the hub, including a central portion forming a hub body connected to the shaft, a peripheral portion forming a rim connected to the storage ring and an intermediate part consisting of a disk between the hub body and the rim, is made from composite material and has a stiffness modulus decreasing from the hub body to the rim.

2. The inertia wheel as claimed in claim 1, wherein the hub is produced by drape forming and shaping composite plies.

3. The inertia wheel as claimed in claim 2, wherein the drape forming produces a pattern including an average number of superposed plies decreasing from the hub body to the peripheral portion of the rim.

4. The inertia wheel as claimed in claim 2, wherein the drape forming includes a succession of plies offset angularly and overlapping at least in the central portion of the hub.

5. The inertia wheel as claimed in claim 1, wherein the hub body includes a cut-out to receive the shaft.

6. The inertia wheel as claimed in claim 5, wherein the hub body is produced by stamping the central portion of the hub.

7. The inertia wheel as claimed in claim 1, wherein the rim is produced by curving the periphery of the disk.

8. The inertia wheel as claimed in claim 1, wherein the hub body is produced by stamping the central portion of the hub, the rim produced by curving the periphery of the disk and the hub body forms a receiving tube for the shaft, is fastened to the shaft and is connected to the disk at one of its ends by a first curve, the rim being connected to the disk by a second curve in the same sense as the first curve.

9. The inertia wheel as claimed in claim 8, wherein the second curve forms a flexible connection between the disk and the rim conferring on the rim a radial modulus of elasticity adapted to allow deformation thereof to follow the deformations of the rotating storage ring.

10. The inertia wheel as claimed in claim 1, wherein the hub is produced by drape forming with plies the fibers of which are for the most part oriented radially relative to the center of the hub.

11. The inertia wheel as claimed in claim 10, wherein the drape forming is carried out with plies formed by longitudinal strips disposed with an angular offset relative to one another and centered on the center of the hub.

12. The inertia wheel as claimed in claim 10, wherein the longitudinal strips are of rectangular or even trapezoidal general shape.

13. The inertia wheel as claimed in claim 1, wherein the hub body consists of an area of overlapping of all the plies, the disk consists of an area of reduced overlapping of the plies, and the rim consists of an area of minimum overlapping of the plies.

14. The inertia wheel as claimed in claim 1, wherein the orientation of the fibers of the plies confers on the rim a circumferential modulus of elasticity adapted to allow deformation thereof to follow the deformations of the rotating storage ring.

15. The inertia wheel as claimed in claim 1, wherein the hub includes a flexible peripheral portion the circumferential stiffness of which is reduced relative to the center of the hub so that the rim follows the deformations of the storage ring.

16. A method of producing an inertial wheel according to claim 1 including a composite material hub, method comprising:
a step of producing a plane blank of the hub by depositing composite plies in accordance with a pattern producing a mean thickness of the blank decreasing from the center to the periphery of the blank,
a step of cutting a central opening in the blank,
a step of pressing the blank in a tool conforming the blank into a cup having at its center an annular hub body and at its periphery a rim, and
a step of polymerizing the hub.

17. The method as claimed in claim 16, wherein the composite plies being longitudinal strips, the composite plies are deposited by placing strips centered on the center of the hub with an angular offset of the strips relative to one another.

18. The method as claimed in claim 17, wherein a step of trimming the blank is carried out after the pressing step.

19. Method of producing an inertia wheel according to claim 1 including a composite material hub, the method comprising:
a step of producing a plane blank of the hub by depositing composite plies in accordance with a pattern producing a mean thickness of the blank decreasing from the center to the periphery of the blank on a mold in the shape of a torus conforming the blank into a cup having at its center an annular hub body (2a) and at its periphery a rim,
a step of cutting a central opening in the blank, and
a step of polymerizing the hub.

20. The method as claimed in claim 16, comprising a step of mating the hub body to a rotation shaft of the wheel.

21. The method as claimed in claim 20 comprising a step of binding the hub body onto the shaft.

22. The method as claimed in claim 20, comprising a step of mating the ring of the wheel to the rim of the hub.

23. The method as claimed in claim 22 comprising a step of mating at least one second hub with the same orientation to the shaft and to the ring.
